(19) United States
(12) Patent Application Publication
(10) Pub. No.: US 2020/0317320 A1
(43) Pub. Date: Oct. 8, 2020

(54) DOOR LATCH ARRANGEMENT

(71) Applicant: Rohr, Inc., Chula Vista, CA (US)

(72) Inventor: Timothy Gormley, Bonita, CA (US)

(21) Appl. No.: 16/377,669

(22) Filed: Apr. 8, 2019

(51) Int. Cl. B64C 1/14; E05B 65/06

(52) U.S. Cl. CPC B64C 1/1423; E05Y 2900/531; E05Y 2900/502; E05B 65/06

(57) ABSTRACT

A latch arrangement for a door includes a plurality of steps disposed at an interior of the door. One of the plurality of steps is rotatable relative to the door between a first position and a second position. The door is movable between a closed position and an open position. A latch is in operable communication with the rotatable step. The latch is engageable with a latch receiver to lock the door in the closed position in response to the rotatable step being in the first position. The latch is disengageable from the latch receiver when the step is in the second position thereby allowing the door to move to the open position.

### BACKGROUND

### 1. Technical Field

This disclosure relates generally to aircraft doors, and more particularly to an aircraft door latching arrangement.

### 2. Background Information

Some commercial and business jet aircraft may include a passenger door which is hinged at or near the bottom of the door, opens outward, and provides a series of steps when the door is in the open or deployed position. These steps form the interior surface of the door. In some cases, it may be necessary to add an additional deployable step at the top of the door such that, when deployed, there is a comfortable step distance from the ground to the deployable step, and then to the series of steps built into the door.

Another feature of this type of aircraft door is that it may contain a manual-type locking, lifting, and/or venting arrangement that is driven via a handle disposed, for example, on a side of the door. However, tight geometric conditions in the vicinity of the door may present users, such as passengers or flight crew members, with a pinch hazard when operating the handle. Further, the user may be forced to operate the handle from a position which causes the user to assume an uncomfortable posture or requires the user to operate the handle with a single-handed operation. Further, the handle adds additional weight and space requirements to door. Accordingly, an improved system for operating an aircraft door is desirable.

### SUMMARY

According to an embodiment of the present disclosure, a latch arrangement for a door includes a plurality of steps disposed at an interior of the door. One of the plurality of steps is rotatable relative to the door between a first position and a second position. The door is movable between a closed position and an open position. A latch is in operable communication with the rotatable step. The latch is engageable with a latch receiver to lock the door in the closed position in response to the rotatable step being in the first position. The latch is disengageable from the latch receiver when the step is in the second position thereby allowing the door to move to the open position.

In the alternative or additionally thereto, in the foregoing embodiment, a width of the rotatable step is defined between a first door end and a second door end. Each door end extends between a top and a bottom of the door.

In the alternative or additionally thereto, in the foregoing embodiment, the door is rotatable about a hinge axis proximate the bottom of the door.

In the alternative or additionally thereto, in the foregoing embodiment, with the rotatable step in the first position the latch extends outward from one of the first door end and the second door end.

In the alternative or additionally thereto, in the foregoing embodiment, the rotatable step is disposed between the other steps of the plurality of steps and the top of the door.

In the alternative or additionally thereto, in the foregoing embodiment, each step of the plurality of steps includes a step surface and each step surface is substantially parallel to each other step surface when the rotatable step is in the second position.

In the alternative or additionally thereto, in the foregoing embodiment, the door further includes a handrail extending from the interior of the door and mounted to the door at a position proximate one of the first door end and the second door end.

According to another embodiment of the present disclosure, an aircraft includes a fuselage and a door mounted to the fuselage by at least one hinge. The door includes a latch arrangement including a plurality of steps disposed at an interior of the door. One of the plurality of steps is rotatable relative to the door between a first position and a second position. The door is movable between a closed position and an open position. A latch is in operable communication with the rotatable step. The latch is engageable with a latch receiver to lock the door in the closed position in response to the rotatable step being in the first position. The latch is disengageable from the latch receiver when the step is in the second position thereby allowing the door to move to the open position.

In the alternative or additionally thereto, in the foregoing embodiment, an exterior surface of the door forms a portion of an exterior surface of the fuselage in the closed position.

In the alternative or additionally thereto, in the foregoing embodiment, a width of the rotatable step is defined between a first door end and a second door end. Each door end extends between a top and a bottom of the door.

In the alternative or additionally thereto, in the foregoing embodiment, the at least one hinge mounts the door to the fuselage proximate the bottom of the door and the door is rotatable about a hinge axis of the at least one hinge.

In the alternative or additionally thereto, in the foregoing embodiment, with the rotatable step in the first position the latch extends outward from one of the first door end and the second door end.

In the alternative or additionally thereto, in the foregoing embodiment, the rotatable step is disposed between the other steps of the plurality of steps and the top of the door.

In the alternative or additionally thereto, in the foregoing embodiment, each step of the plurality of steps includes a step surface and each step surface is substantially parallel to each other step surface when the rotatable step is in the second position.

In the alternative or additionally thereto, in the foregoing embodiment, the door further includes a handrail extending from the interior of the door and mounted to the door at a position proximate one of the first door end and the second door end.

According to another embodiment of the present disclosure, a method for opening a door of an aircraft is provided. A rotatable step of a plurality of steps is rotated from a first position to a second position relative to the door to disengage a latch from a latch receiver. The door is moved from a closed position to an open position. The plurality of steps is disposed at an interior of the door.

In the alternative or additionally thereto, in the foregoing embodiment, the latch is in operable communication with the rotatable step.

In the alternative or additionally thereto, in the foregoing embodiment, a width of the rotatable step is defined between a first door end and a second door end. Each door end extends between a top and a bottom of the door.

In the alternative or additionally thereto, in the foregoing embodiment, the rotatable step is disposed between the other steps of the plurality of steps and the top of the door.

In the alternative or additionally thereto, in the foregoing embodiment, each step of the plurality of steps includes a step surface and each step surface is substantially parallel to each other step surface when the rotatable step is in the second position.

The present disclosure, and all its aspects, embodiments and advantages associated therewith will become more readily apparent in view of the detailed description provided below, including the accompanying drawings.

### BRIEF DESCRIPTION OF THE DRAWINGS

FIG. 1 illustrates a perspective view of an aircraft including a door.

FIG. 2A illustrates a perspective view of an exemplary latch arrangement for a door of an aircraft in a closed position.

FIG. 2B illustrates another perspective view of the latch arrangement of FIG. 2A.

FIG. 3A a perspective view of the latch arrangement of FIG. 2A with the door in an open position.

FIG. 3B illustrates another perspective view of the latch arrangement of FIG. 3A.

### DETAILED DESCRIPTION

It is noted that various connections are set forth between elements in the following description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

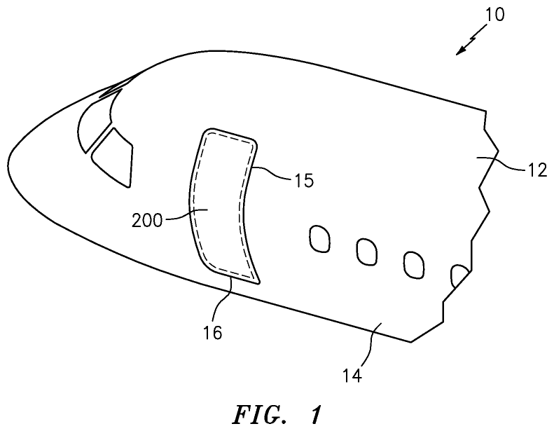

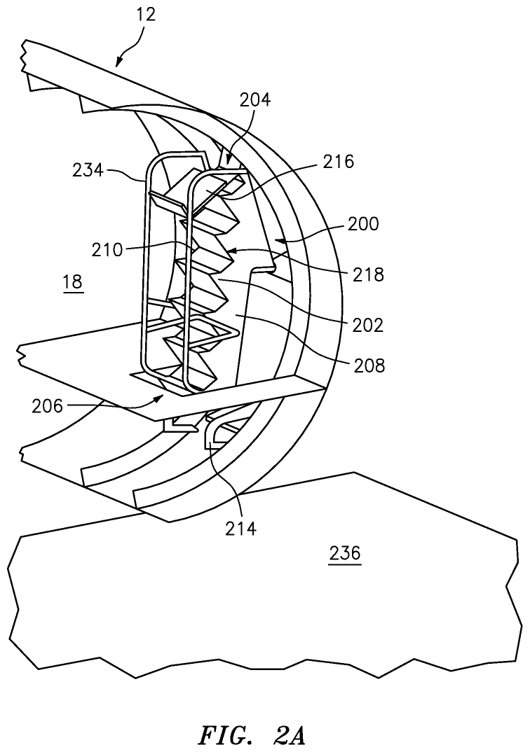

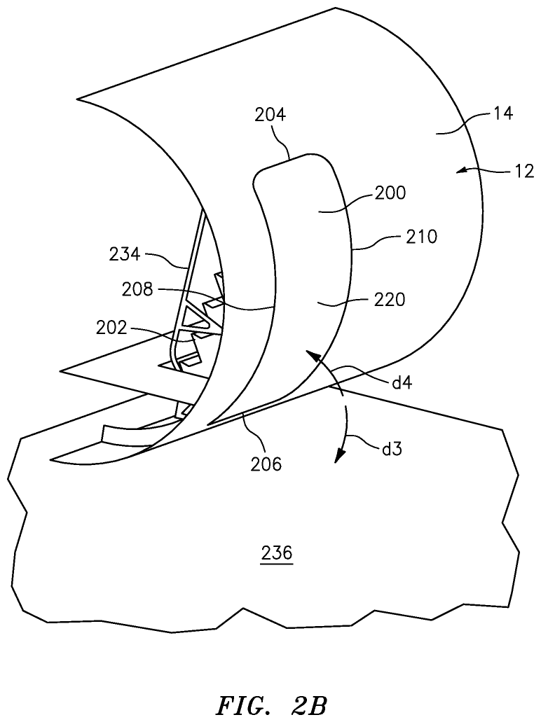

As illustrated in FIG. 1, an aircraft 10 includes a fuselage 12 having an exterior surface 14. The fuselage 12 includes a door frame 15 defining a door opening 16 disposed through the fuselage 12 to permit ingress to and egress from a cabin 18 (not shown, see FIG. 2A) of the aircraft 10, for example, by passengers and crew members of the aircraft 10. The fuselage 12 includes a door 200 configured to fit within the door frame 15 and to seal the door opening 16 during flight operations or other times when ingress and/or egress through the door opening 16 is not desirable.

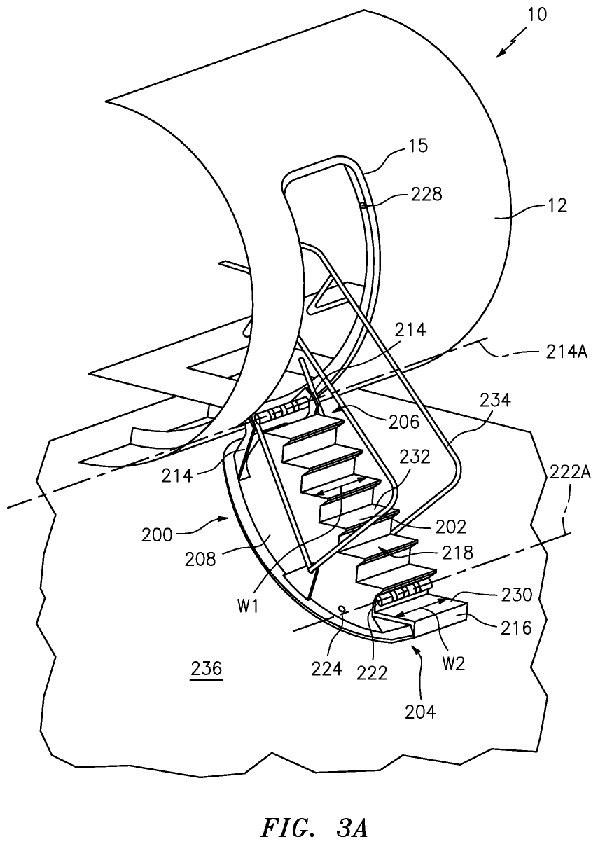

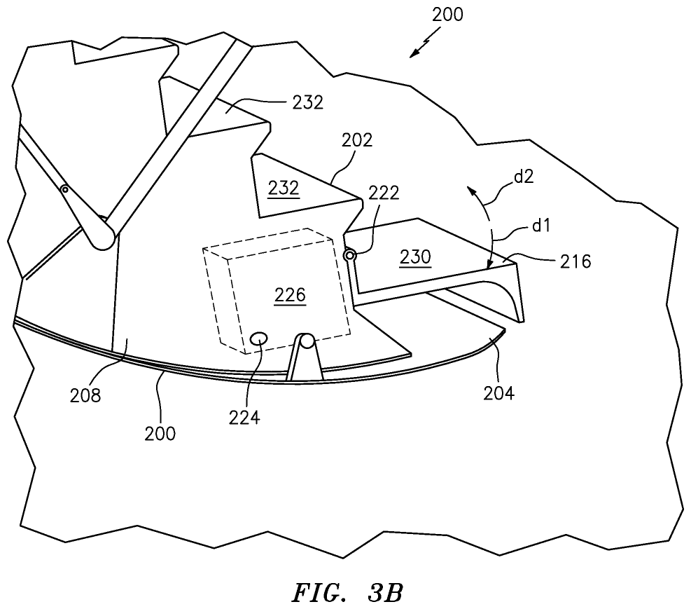

Referring to FIGS. 2A, 2B, 3A, and 3B, the door 200 includes an interior side 218 and an exterior side 220. The interior side 218 includes a plurality of integral steps 202 extending from the interior side 218 in series between a top 204 and a bottom 206 of the door 200. Each step of the plurality of integral steps 202 has a width W1 defined between a first door end 208 and a second door end 210 of the door 200. The door 200 is rotatably mounted to the fuselage 12 by at least one hinge 214 (e.g., a gooseneck hinge) proximate the bottom 206 of the door 200. The door 200 is configured for rotation about a hinge axis 214A of the at least one hinge 214 between an open position (see, e.g., FIGS. 3A and 3B) and a closed position (see, e.g., FIGS. 2A and 2B). With the door 200 in the open position, passengers may use the plurality of integral steps 202 for ingress or egress between the cabin 18 and the ground 236 or a platform disposed proximate the aircraft 10 to interface with the door 200.

It should be noted that the top 204 and bottom 206 of the door 200 refer to the “top” and “bottom” of the door when the door is in the closed position. However, the top 204 and bottom 206 of the door 200 will be used to refer to the same portion of the door 200 in both of the open and closed positions. Further, as used herein, a “closed position” will be used to refer to the door 200 in a position so as to form a substantially continuous exterior surface 14 with the fuselage 12 (e.g., the door 200 is positioned for flight). The “open position” will be used to refer to the door 200 in a fully-open position so as to permit passenger ingress/egress between the cabin 18 and the ground 236.

The door 200 includes at least one rotatable step 216 extending from the interior side 218 in series with the plurality of integral steps 202 between the top 204 bottom 206 of the door 200. The at least one rotatable step 216 is rotatably mounted to the interior side 218 by at least one hinge 222 and is configured for rotation about a hinge axis 222A of the at least one hinge 222 between a stowed position (see, e.g., FIG. 2A) and a deployed position (see, e.g., FIGS. 3A and 3B). The at least one rotatable step 216 in the deployed position is configured to provide a more comfortable step distance for passengers, for example, between the ground 236 and the integral step 202 most proximate the top 204 of the door 200 when the door 200 is in the open position.

In the illustrated embodiment, the at least one rotatable step 216 has a width W2 defined between the first door end 208 and the second door end 210 of the door 200. However, in some embodiments, the width W2 of the at least one rotatable step 216 may be equal to or less than the distance between the first door end 208 and the second door end 210. In some embodiments, a step surface 230 of the at least one rotatable step 216 in the deployed position may be substantially parallel to a step surface 232 of each of the plurality of integral steps 202. As used herein, the term “substantially” with regard to an angular relationship refers to the noted angular relationship +/−5 degrees.

The door 200 includes a latch assembly 226 having at least one latch 224 configured to secure the door 200 in the closed position. For example, the at least one latch 224 may extend from the door 200 to engage with a respective latch receiver 228 disposed in the door frame 15, thereby securing the door 200 in the closed position. The latch receiver 228 may be, for example, a surface of the door frame 15 about an aperture disposed through the door frame 15 and configured to align with the at least one latch 224 when the door 200 is in the closed position. Alternatively, the at least one latch 224 may be retracted into the door, thereby disengaging the at least one latch 224 from the latch receiver 228 permitting the door 200 to be rotated from the closed position to the open position. In some embodiments, the latch assembly 226 may further include a handle disposed on the exterior side 220 of the door 200 and accessible from a position outside the aircraft 10. The exterior handle may be configured to engage or disengage the at least one latch 224.

The at least one latch 224 is in operable communication with the at least one rotatable step 216. Operation of the at least one latch 224 (i.e., effecting engagement or disengagement of the at least one latch 224 with the door frame 15) is effected by the at least one rotatable step 216. For example, rotation of the at least one rotatable step 216 in direction d1, from the stowed position to the deployed position, disengages the at least one latch 224 thereby effecting, at least in part, a repositioning of the door 200 by permitting the door 200 to be repositioned from the closed position to the open position. Subsequently, the door 200 may be rotated by a passenger or crew member (hereinafter “user”) in direction d3 from the closed position to the open position. Alternatively, when securing the door 200, a user may rotate the door in direction d4 to the closed position and subsequently engage the at least one latch 224 by rotating the at least one rotatable step 216 in direction d2 to the stowed position.

The latch assembly 226 may be in operable communication with the at least one rotatable step 216 and the at least one latch 224 such that operation of the at least one rotatable step 216 effects a corresponding operation of the at least one latch 224 via the latch assembly 226. Operable communication of the latch assembly 226 between the at least one latch 224 and the at least one rotatable step 216 may include mechanical, electrical, or suitable communication which may be accomplished by any suitable means conventionally known in the art. Rotation of the at least one rotatable step 216 from the stowed position to the deployed position may additionally effect rotation of the door 200 (e.g., by a hydraulic, pneumatic, spring biasing, or other suitable actuation device) and/or venting of the cabin 18.

In some embodiments, the at least one rotatable step 216 may include a plurality of rotatable steps 216, for example, when an excessive step distance must be addressed at multiple points between the cabin 18 and the ground 236. The plurality of rotatable steps 216 may include an actuating rotatable step, similar to the at least one rotatable step 216 described above, configured to effect engagement and disengagement of the at least one latch 224. The plurality of rotatable steps 216 may further include one or more non-actuating rotatable steps which do not effect engagement and disengagement of the at least one latch 224.

In some embodiments, the door 200 may include at least one handrail 234 configured to assist passengers with ingress or egress to or from the cabin 18. As shown in FIGS. 2A and 3A, the at least one handrail 234 may extend from the interior side 218 of the door 200 and may be mounted to the door 200 at one or more positions proximate one of the first door end 208 and the second door end 210.

According to aspects of the present disclosure, operation of the at least one latch 224 without a conventional independent handle may provide a reduction in the weight of the door 200, and as a result, the weight of the aircraft 10. Additionally, the location of the at least one rotatable step 216 proximate the top of the door 200 and between the first door end 208 and the second door end 210 may permit a user to operate the at least one rotatable step 216 with two hands from an upright postural position.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. Accordingly, the present disclosure is not to be restricted except in light of the attached claims and their equivalents.

What is claimed is:

1. A latch arrangement for a door comprising:
a plurality of steps disposed at an interior of the door, one of the plurality of steps being rotatable relative to the door between a first position and a second position, the door being movable between a closed and an open position; and
a latch in operable communication with the rotatable step, the latch being engageable with a latch receiver to lock the door in the closed position in response to the rotatable step being in the first position, the latch being disengageable from the latch receiver when the step is in the second position thereby allowing the door to move to the open position.

2. The latch arrangement of claim 1, wherein a width of the rotatable step is defined between a first door end and a second door end, each door end extending between a top and a bottom of the door.

3. The latch arrangement of claim 2, wherein the door is rotatable about a hinge axis proximate the bottom of the door.

4. The latch arrangement of claim 2, wherein with the rotatable step in the first position the latch extends outward from one of the first door end and the second door end.

5. The latch arrangement of claim 1, wherein the rotatable step is disposed between the other steps of the plurality of steps and the top of the door.

6. The latch arrangement of claim 1, wherein each step of the plurality of steps comprises a step surface and each step surface is substantially parallel to each other step surface when the rotatable step is in the second position.

7. The latch arrangement of claim 4 further comprising a handrail extending from the interior of the door and mounted to the door at a position proximate one of the first door end and the second door end.

8. An aircraft comprising:
a fuselage; and
a door mounted to the fuselage by at least one hinge, the door comprising a latch arrangement including:
a plurality of steps disposed at an interior of the door, one of the plurality of steps being rotatable relative to the door between a first position and a second position, the door being movable between a closed and an open position; and
a latch in operable communication with the rotatable step, the latch being engageable with a latch receiver to lock the door in the closed position in response to the rotatable step being in the first position, the latch being disengageable from the latch receiver when the step is in the second position thereby allowing the door to move to the open position.

9. The aircraft of claim 8, wherein an exterior surface of the door forms a portion of an exterior surface of the fuselage in the closed position.

10. The aircraft of claim 8, wherein a width of the rotatable step is defined between a first door end and a second door end, each door end extending between a top and a bottom of the door.

11. The aircraft of claim 10, wherein the at least one hinge mounts the door to the fuselage proximate the bottom of the door and the door is rotatable about a hinge axis of the at least one hinge.

12. The aircraft of claim 10, wherein with the rotatable step in the first position the latch extends outward from one of the first door end and the second door end.

13. The aircraft of claim 8, wherein the rotatable step is disposed between the other steps of the plurality of steps and the top of the door.

14. The aircraft of claim 8, wherein each step of the plurality of steps comprises a step surface and each step surface is substantially parallel to each other step surface when the rotatable step is in the second position.

15. The aircraft of claim 8, wherein the door further comprises a handrail extending from the interior of the door and mounted to the door at a position proximate one of the first door end and the second door end.

16. A method for opening a door of an aircraft, the method comprising:
rotating a rotatable step of a plurality of steps from a first position to a second position relative to the door to disengage a latch from a latch receiver; and
moving the door from a closed position to an open position;
wherein the plurality of steps is disposed at an interior of the door.

17. The method of claim 16, wherein the latch is in operable communication with the rotatable step.

18. The method of claim 16, wherein a width of the rotatable step is defined between a first door end and a second door end, each door end extending between a top and a bottom of the door.

19. The method of claim 16, wherein the rotatable step is disposed between the other steps of the plurality of steps and the top of the door.

20. The method of claim 16, wherein each step of the plurality of steps comprises a step surface and each step surface is substantially parallel to each other step surface when the rotatable step is in the second position.
